(19) United States
(12) Patent Application Publication
(10) Pub. No.: US 2025/0319719 A1
(43) Pub. Date: Oct. 16, 2025

(54) Storage Bin Insert

(71) Applicant: Cut It Out Scrapbook Supplies, Inc., Crystal Lake, IL (US)

(72) Inventor: Angela Guibord, Crystal Lake, IL (US)

(21) Appl. No.: 19/176,423

(22) Filed: Apr. 11, 2025

Related U.S. Application Data
(60) Provisional application No. 63/633,195, filed on Apr. 12, 2024.

(51) Int. Cl. B43K 23/04; B65D 25/10

(52) U.S. Cl. CPC B43K 23/04; B65D 25/108

(57) ABSTRACT

A storage grid assembly used for securing scrapbooking markers includes a first stability plate having a plurality of equally sized openings coordinated in rows and columns, a second stability plate being substantially identical to the first stability plate, and a plurality of spacer assemblies for securing to each of the first and second stability plates and retaining the stability plates in a spaced apart and parallel orientation. A storage system for securing scrapbooking markers includes the grid device as well as a storage container having a base with four sides and a removable lid, wherein the storage grid device fits securely within the base of the storage container.

### TECHNICAL FIELD OF THE INVENTION

The present invention relates to storage systems. More specifically, the invention relates to a storage system for objects such as markers as used in scrapbooking.

### BACKGROUND OF THE INVENTION

Scrapbooking is a crafting and documenting activity that involves taking books with blank pages and adding photos, memorabilia, journaling, and embellishments. Also known as cropping, the primary purpose of scrapbooking is to preserve memories for future generations, but a secondary purpose often is to exercise creativity in an attempt to display relevant memories in a scrapbook.

Incredibly, as a hobby scrapbooking has been around since about the 15th century. In its early stages, scrapbooking was simply a collection contained in a book. These collections could include recipes, greeting cards, snippets of paper memorabilia, tickets, or playbills. In the 1980s, scrapbooking as we know it today started as an off shoot of the Mormon's desire to preserve their family and religious history. As the idea spread, it reached a mass audience of home photographers who wished to record and preserve their families' memories for the future.

The hobby became immensely popular from 2001 to 2005, blossoming to a $2.5 billion industry with over 1,600 companies creating scrapbooking products by 2003. The rise of bloggers who would post about scrapbooking likely helped the hobby grow in popularity, and digital scrapbooking is also popular, allowing people to share creations online and print hard copies.

Scrapbooking is still popular today because it continues to help people document their families' lives and socialize with others while crafting. More than four million people in the United States are said to be scrapbookers. Other crafts and hobbies have worked their way under the scrapbooking umbrella, such as using decorative planners and adult coloring. There has also been a rise in trade shows dedicated to scrapbooking, such as the Stamp and Scrapbook EXPO and the National Art Materials Trade Association (NAMTA), formerly the Craft and Hobby Association (CHA).

Basic supplies for scrapbooking, other than the scrapbook itself, include at least one good pair of scissors, lots of colorful and decorative paper, glue, stickers, and other embellishments that can be used to create one-of-a-kind scrapbook pages.

Additionally, many scrapbookers like to add handwritten notes to their memory pages using special pens and markers. In fact, there are over 350 different marker colors used specifically for scrapbooking. With prices ranging from $5.00 to $10.00 per marker, tossing these valuable tools into a tote or bin could be costly. Further, many of these special markers, like fine wine, are best when stored horizontally. Being able to find just the right marker color in an instant is a great value to any scrapbooking aficionado. Also, the ability to effectively store and transport a large collection of pens and markers in an organized manner with other scrapbooking tools provides an immense time savings, as scrapbookers travel between events.

Accordingly, what is needed for the crafting industry is a system which provides the ability to store and transport hundreds of valuable pens and markers together safely and securely. Specifically, the system should also include a way for displaying all the pens and markers so that they are readily accessible, and the colors are easily discernible. Finally, the system should permit the pens and markers to be displayed and stored horizontally, as is best.

Until the invention of the present application, these and other problems in the prior art went either unnoticed or unsolved by those skilled in the art. The present invention provides a marker storage system which performs multiple functions with the associated storage bin without sacrificing portability, design, style, or affordability.

### SUMMARY OF THE INVENTION

There is disclosed herein an improved storage device and system which avoids the disadvantages of prior devices while affording additional structural and operating advantages.

Generally speaking, the storage system is used for securing scrapbooking markers and comprises a first stability plate having a plurality of equally sized openings coordinated in rows and columns, a second stability plate being substantially identical to the first stability plate, and a plurality of spacer assemblies for securing to each of the first and second stability plates and retaining the stability plates in a spaced apart and parallel orientation.

In specific embodiments, the spacer assemblies comprise spacer tubes, plate engagement washers, and locking pins (e.g., bolts). Preferably, the spacer tubes have a threaded interior, and the locking pins have a corresponding threaded exterior, and the two components engage one another to secure each stability plate. Further, the engagement washers have a raised area which corresponds to the opening shape on each stability plate.

A storage system for securing scrapbooking markers includes the above device as well as a storage container having a base with four sides and a removable lid, wherein the storage grid device fits securely within the base of the storage container.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a top perspective view showing an embodiment of the disclosed storage device within a storage bin;

FIG. 2 is a perspective view of an embodiment of the disclosed storage device;

FIG. 3 is an exploded perspective view of the embodiment shown in FIG. 2;

FIG. 4A is a side view of an embodiment of a disclosed spacer component;

FIG. 4B is a top view of the disclosed spacer component shown in FIG. 4A;

FIG. 5A is a side view of an embodiment of a disclosed washer component;

FIG. 5B is a top view of the disclosed washer component of FIG. 5A;

FIG. 6 is a side view of an embodiment of the disclosed bolt;

FIG. 7 is a top plan view of an embodiment of top and bottom grid plates of the storage device shown in FIG. 2;

FIG. 8 is a cut-away, close-up view of several grid squares of the grid plate of FIG. 7;

FIG. 9 is a side view of an embodiment of the disclosed storage device similar to the storage device of FIG. 2;

FIG. 10 is a top view of the storage device of FIG. 9;

FIG. 11 is a view of a disassembled embodiment of a spacer assembly used for the storage device shown in FIG. 9;

FIG. 12 is a close-up view of the bolt and washer components used in the spacer assembly of FIG. 11;

FIG. 13 is a close-up view of a corner of the storage device shown in FIG. 9;

FIG. 14A is a close-up view of the bolt and washer components; and

FIG. 14B is a close-up view of the components of the spacer assembly used for the storage device of FIG. 9.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

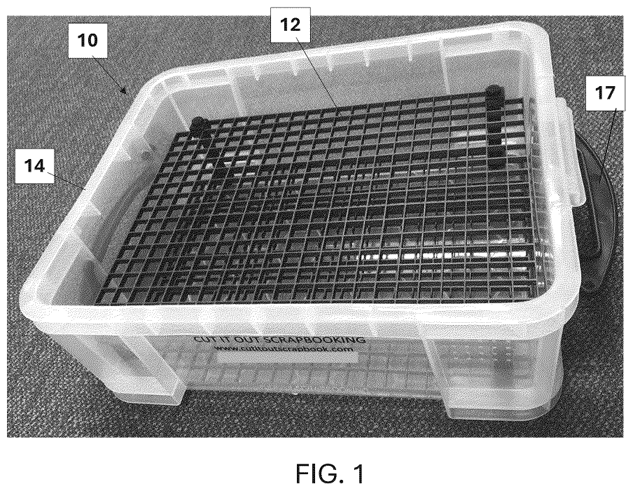

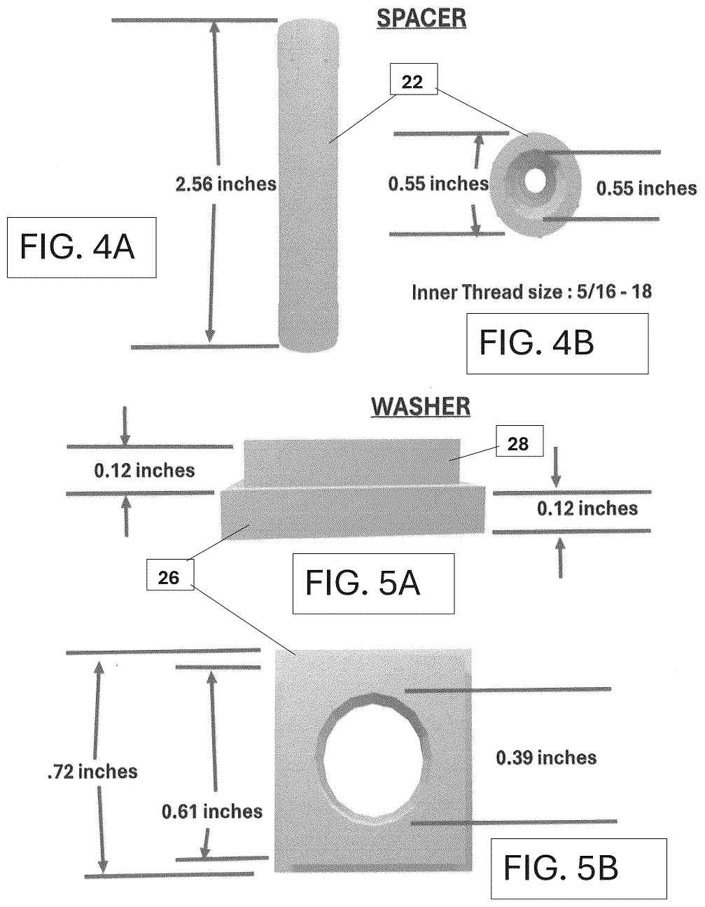

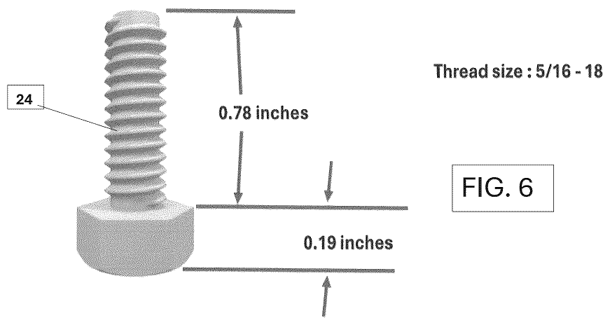

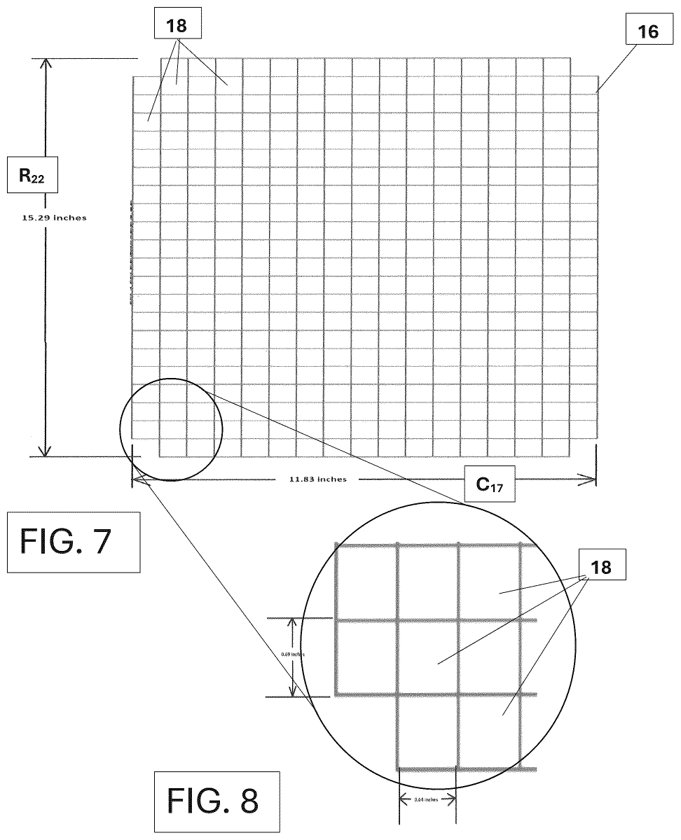

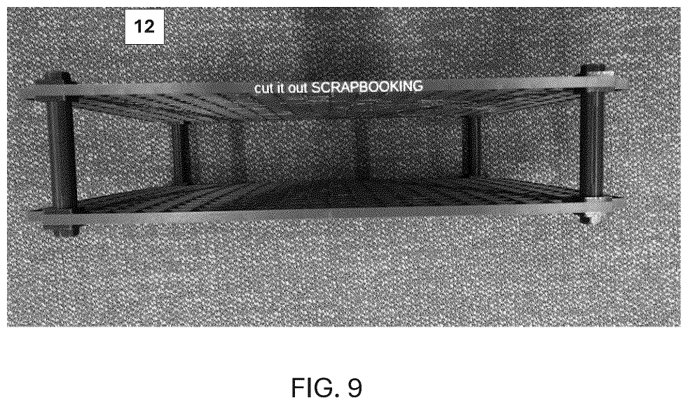

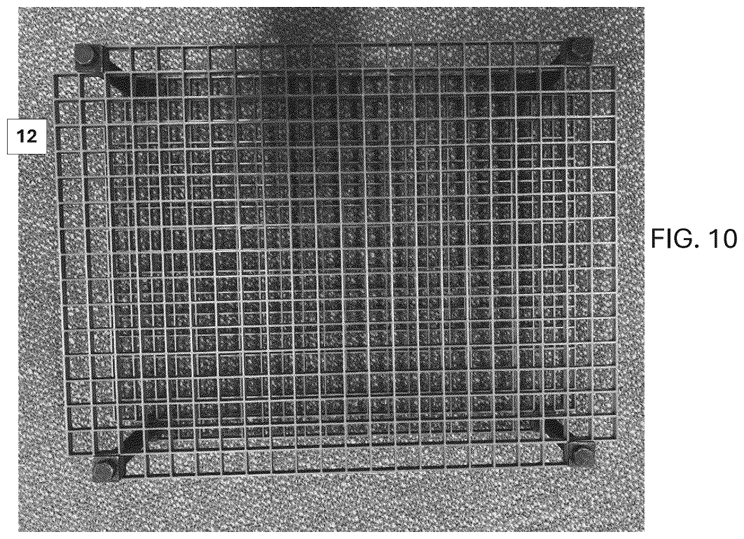

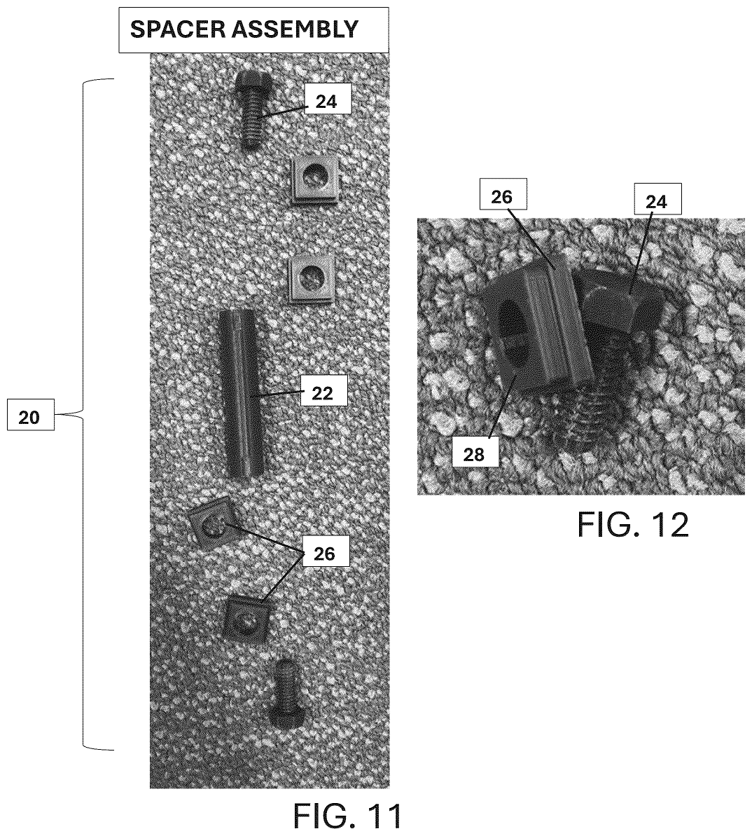

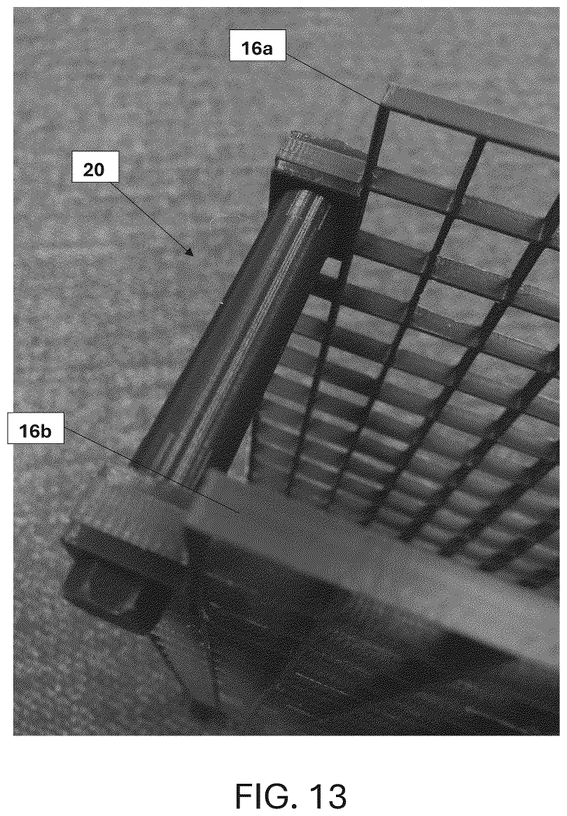

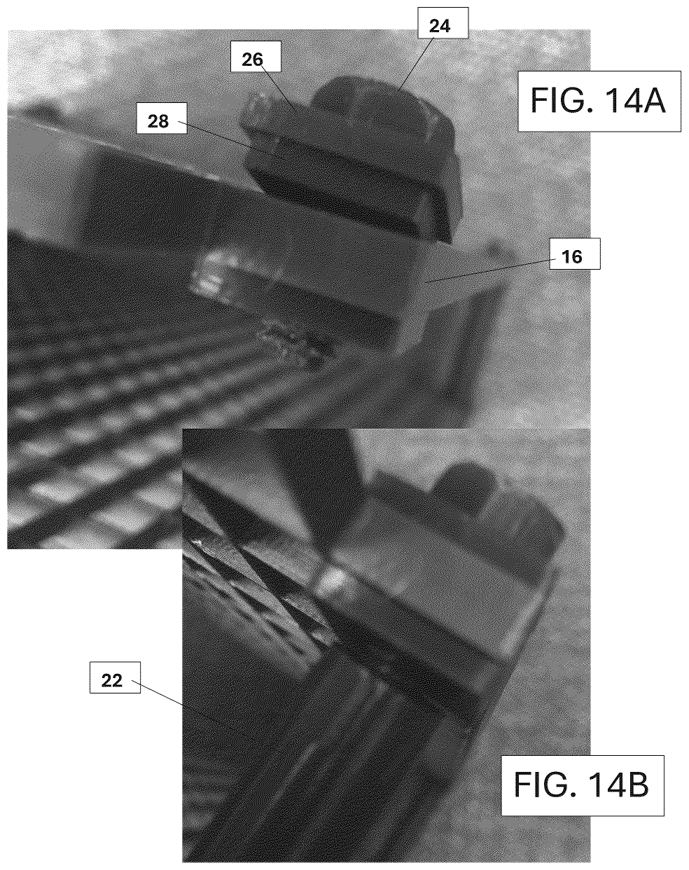

Referring to FIGS. 1-14, there is illustrated a preferred embodiment of a marker storage system, generally designated by the numeral 10, which includes a storage grid device/assembly, designated by the numeral 12. The particular illustrated storage grid device (or assembly) 12 is for the storage, transportation, and display of scrapbooking markers and/or pens when used in conjunction with a storage bin 14 or similar container. However, while all the embodiments illustrated and described are directed to a storage system for markers and/or pens, it should be understood that the principles of the invention may be more broadly applied to a storage system which is useful for tools of other hobbies, occupations, and processes as well.

As can be seen in FIG. 1, the storage grid device 12 is configured to be placed within a suitably sized storage bin 14. Most preferably, the storage bin 14 includes handles 17, a lid (not shown), and means for securing the lid in a closed position, such as latches (not shown). The grid device 12 should be sized to fit snugly within the storage bin 14 to prevent lateral movement of the grid device 12 which might unintentionally release stored items during transportation or the like.

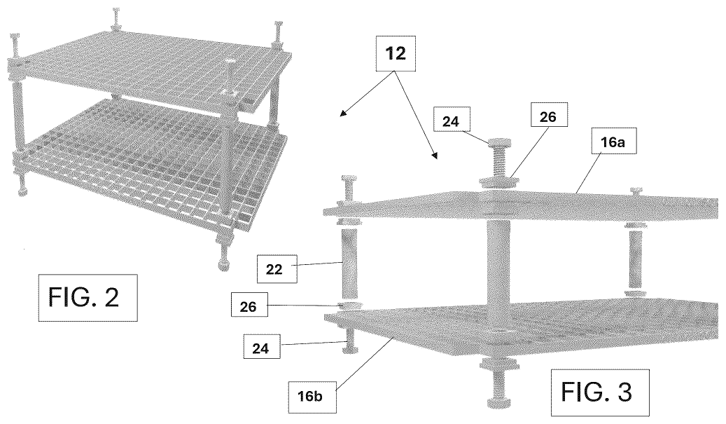

Referring to FIGS. 2, 7, 8, and 10, the storage grid device 12 is comprised of upper and lower (or first and second) stability plates 16a and 16b, respectively. Each of the stability plates 16a-b includes a plurality of storage spaces 18 arranged in columns (C_{X}) and rows (R^{Y}). The openings 18 are preferably square but can be any shape or size which is suitable for properly seating each stored crafting marker/tool. The stability plate 16a-b dimensions (i.e., length (L) and width (W)) are preferably the same for each plate to allow them to be mass produced and readily interchangeable, e.g., for expansion purposes or in the event of loss or breakage.

The illustrated plates 16a-b are constructed to have twenty-two spaces (or squares) in length by seventeen spaces (or squares) wide, yielding three-hundred seventy-four (374) usable storage spaces 18. Four corner spaces are omitted due to the rounded corners of the particular storage bin 14 and four additional spaces are used for the placement of spacer assemblies 20 (explained below), leaving three-hundred sixty-six storage spaces 18 in the illustrated storage grid assembly 12. Both the dimension of the spaces 18 and the dimension of the plates 16 may be altered to suit the intended use and the capacity of the storage bin 14.

Moving to FIGS. 3-6 and 11-14, the spacer assemblies 20 are best illustrated. In the present embodiment, a spacer assembly 20 is positioned proximally to each corner of the parallel stability plates 16. Each spacer assembly 20 is comprised of a hollow spacer 22 which is approximately three inches long, two bolts 24, and four custom washers 26. By “custom” it is meant that the washer 26 includes a raised area 28 on one surface which corresponds with a shape of an opening 30 of the stability grid plate 16. This allows the washer 26 to lock in place and more securely retain the spacer 22 between the parallel stability grid plates 16a and 16b. The interior ends of each spacer 22 are threaded to accommodate a bolt 24 and complete the assembly 20. The stability grid plates 16, spacers 22, washers 26, and bolts 24 are preferably made of the same rigid plastic for durability and stiffness. However, many suitable plastics, polymers, metals, and alloys exist which would be suitable for most applications and uses.

To construct the storage grid device 12, a first (or bottom) grid plate 16a is fitted at each corner with a bolt 24, two washers 26, and a spacer 22. This is achieved by placing the two washers 26 facing each other over a selected space 18 in the stability plate 16a so that the raised area 28 of each washer 26 engages the opening 18 from opposite sides. The bolt 24 is fed through the two washers 26 where a spacer 22 is threaded on to the exposed end. Once this is completed at each of the four corners of the stability plate 16a, a third washer 26 is placed over the upper end of each spacer 22. The upper or second stability plate 16b is placed over this portion of the assembly, making sure each raised area 28 of the four upward facing washers 26 engages a corresponding space 18 of the stability plate 16b. A fourth washer 26 is positioned into the same space 18 for each corner, with the raised area 28 entering the opening. Finally, a bolt 24 is fed through the washers 26 and threaded into the upward end of the spacer 22. The completed grid device 12 is then ready for placement within a storage bin 14.

The resulting storage system 10 can then be filled with markers and/or pens and closed for transport or storage or left open for immediate use. For storage and transport, the system 10 is capable of being positioned on a side for preferred horizontal orientation of the stored markers.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A storage assembly for securing writing utensils, the assembly comprising:
a first stability plate having a plurality of equally sized openings coordinated in rows and columns;
a second stability plate being substantially identical to the first stability plate; and
a plurality of spacers for securing to and between the first and second stability plates and retaining the stability plates in a spaced apart and parallel orientation;
wherein the plurality of equally sized openings on the first stability plate and the second stability plate are aligned.

2. The storage grid of claim 1, wherein the spacers comprise spacing tubes, plate engagement washers, and locking pins.

3. The storage grid of claim 2, wherein the spacing tubes have a threaded interior, and the locking pins have a corresponding threaded exterior, and the two components engage one another to secure to each stability plate.

4. The storage grid of claim 2, wherein the engagement washers have a raised area which corresponds to a shape of the openings of each stability plate.

5. The storage grid of claim 1, wherein the number of equally sized openings is in the range of 250 to 400.

6. The storage grid of claim 5, wherein the number of openings is in the range of 320 to 380.

7. The storage grid of claim 5, wherein the number of openings is in the range of 350 to 370.

8. A storage system for securing scrapbooking markers, the system comprising:
a storage container having a base with four sides and a removable lid;
a storage assembly comprising:
a first stability plate having a plurality of equally sized openings coordinated in rows and columns;
a second stability plate being substantially identical to the first stability plate; and
a plurality of spacers for securing to and between each of the first and second stability plates and retaining the stability plates in a spaced apart and parallel orientation;
wherein the storage assembly fits securely within the base of the storage container.

9. The storage system of claim 8, wherein the spacers comprise spacing tubes, plate engagement washers, and locking pins.

10. The storage system of claim 9, wherein the spacing tubes have a threaded interior, and the locking pins have a corresponding threaded exterior, and the two components engage one another to secure to each stability plate.

11. The storage system of claim 9, wherein the engagement washers have a raised area which corresponds to the openings of each stability plate.

12. The storage system of claim 8, wherein the number of equally sized openings is in the range of 250 to 400.

13. The storage system of claim 12, wherein the number of openings is in the range of 320 to 380.

14. The storage system of claim 12, wherein the number of openings is in the range of 350 to 370.

15. A storage system for securing writing utensils, the system comprising:
a first stability plate having a plurality of equally sized openings coordinated in rows and columns;
a second stability plate being substantially identical to the first stability plate;
a plurality of spacers for securing to and between the first and second stability plates and retaining the stability plates in a spaced apart and parallel orientation to create a storage assembly; and
a container having a cavity sized to retain the storage assembly so as to provide access to the openings of the first stability plate and prevent lateral movement of the storage assembly.
